(19) United States
(12) Patent Application Publication
(10) Pub. No.: US 2023/0419039 A1
(43) Pub. Date: Dec. 28, 2023

(54) Named Entity Recognition Using Capsule Networks

(71) Applicant: Cognizer, Inc., Pleasanton, CA (US)

(72) Inventors: Jack Porter, Valley Springs, CA (US); Soundararajan Velu, Bangalore North (IN); Vineeth Thanikonda Munirathnam, Bangalore (IN); Suzanne M. Kirch, Waltham, MA (US); Rajiv Baronia, San Ramon, CA (US)

(21) Appl. No.: 18/037,766

(22) PCT Filed: Nov. 18, 2021
(86) PCT No.: PCT/US21/59992

§ 371 Date: May 18, 2023

(51) Int. Cl. G06F 40/295

(52) U.S. Cl. CPC G06F 40/295

(57) ABSTRACT

Named Entity Recognition is the identification and classification of named entities within a document. The disclosed invention leverages the CapsNet architecture for improved NE identification and classification. This includes deriving the features of an input text. The derived features are used to identify and classify any named entities in the text. The system is further configured to identify named entities in the text and perform clustering to group named entities. The disclosed CapsNet considers the context of the whole text to activate higher capsule layers in order to identify named entities and classify them.

### CROSS REFERENCE TO RELATED APPLICATIONS

This application claims priority from provisional U.S. patent application No. 63/116,048 filed on Nov. 19, 2020.

### FIELD OF THE INVENTION

Embodiments of the invention generation relate to natural language processing, more particularly to the usage of capsule networks for named entity recognition.

### BACKGROUND

Semantic parsing is the task of transforming natural language text into a machine-readable formal representation. Natural language processing (NLP) involves the use of artificial intelligence to process and analyze large amounts of natural language data. Named Entity Recognition (NER) is the identification and classification of named entities within a document. Traditionally, an NER model identifies the named entity (NE) as belonging to a class in a predefined set of classes. Possible classifications of named entities in different NER models include person, location, artifact, award, media, team, time, monetary value, etc.

An NER model helps identify key information to understand what a document is about, either as text summarization or as a starting point for additional processing. Additionally, NER can be used to identify how to correctly handle data in a given document based on a specific named entity or named entity class. For example, if the primary named entity in a document is a person, certain security measures may need to be taken for the data.

Common NER models utilize a Bidirectional Long Short Term Memory (BiLSTM) encoder and Conditional Random Field (CRF) decoder. Bidirectional LSTMs consist of a pair of LSTMs, where one is trained from left-to-right (forward), and the other is trained from right-to-left (backward). However, because they are two separate LSTMs, neither of them look at both directions at the same time and thus are not truly bidirectional. Each LSTM can only consider the context on one side of the NE at a time. The model is not able to consider the full context of the named entity to efficiently determine the correct class that the named entity belongs to. Other previous methods include contextual word embeddings from Bidirectional Encoder Representations from Transformers (BERT), Embeddings from Language Models (ELMo), and Flair. Further shortcomings of these models include their inability to consider and understand semantic features and being limited to a small set of named entity classes.

Capsule Neural Networks (CapsNet) are machine learning systems that model hierarchical relationships. CapsNets were introduced in the image classification domain, where they are configured to receive as input an image and to process the image to perform image classification or object detection tasks. CapsNet improves on Convolutional Neural Networks (CNN) through the addition of the capsule structure and is better suited to outputting the orientation of an observation and pose of an observation compared to CNN. Thus, it can train on a comparatively lesser number of data points with a better performance in solving the same problem. The dynamic routing algorithm groups capsules together to activate higher level parent capsules. Over the course of iterations, each parents' outputs may converge with the predictions of some children and diverge from those of others, thus removing a lot of unnecessary activations in the network, ultimately until the capsules reach an agreement.

### SUMMARY

Named Entity Recognition is the identification and classification of named entities within a document. The disclosed invention leverages the CapsNet architecture for improved NE identification and classification. This includes deriving the features of an input text. The derived features are used to identify and classify any named entities in the text. The system is further configured to identify named entities in the text and perform clustering to group named entities. The disclosed CapsNet considers the context of the whole text to activate higher capsule layers in order to identify the named entities and classify them.

A computer-implemented method for identifying and classifying named entities in a natural language text is provided. This includes receiving, into a neural capsule embedding network as input, an embedding vector, where the embedding vector contains embeddings representing words in a natural language text, analyzing, by the neural capsule embedding network, the context of each word within the embedding vector considering tokens to the left and right of the word, through dynamic routing of capsules, by the neural capsule embedding network, converging to a final capsule layer mapping to each word in the input vector, and generating, from the neural capsule embedding network, an output vector, wherein each output vector value identifies if a word in the input is a named entity or not a named entity and if the word is a named entity, identifies what class the named entity belongs to. The classes can be a predefined set of named entity classes or clusters determined by the neural capsule embedding network.

The input can be a natural language text, where the words in the natural language text are converted into embeddings and inserted into an embedding vector during preprocessing. The target word in the natural language text can be identified during preprocessing. The features of the natural language text can be identified during preprocessing. The features can be included in the embedding vector as feature embeddings. The features can also be identified by the Neural Capsule Embedding Network.

### BRIEF DESCRIPTION OF THE DRAWINGS

The accompanying drawings taken in conjunction with the detailed description will assist in making the advantages and aspects of the disclosure more apparent.

FIG. 1 depicts a system configured to identify and classify named entities in a natural language input.

FIG. 2 depicts an NER Capsule Network embodiment configured to identify and classify named entities in a natural language input.

FIG. 3 depicts words in an input text converted to numerical representations called embeddings.

FIG. 4 depicts the dynamic routing of capsules between layers in a capsule network.

FIG. 5 depicts an alternative NER Capsule Network embodiment configured to identify and classify named entities in a natural language input.

FIG. 6 depicts a process of converting an output vector to an output matrix.

### DETAILED DESCRIPTION OF THE INVENTION

Reference will now be made in detail to the present embodiments discussed herein, illustrated in the accompanying drawings. The embodiments are described below to explain the disclosed method, system, apparatus, and program by referring to the figures using like numerals.

The subject matter is presented in the general context of program modules and/or in computer hardware, including the structures disclosed in this specification and their structural equivalents, or in combinations of one or more of them. Those skilled in the art will recognize that other implementations may be performed in combination with other types of program and hardware modules that may include different data structures, components, or routines that perform similar tasks. The invention can be practiced using various computer system configurations and across one or more computers, including, but not limited to, clients and servers in a client-server relationship. Computers encompass all kinds of apparatus, devices, and machines for processing data, including by way of example one or more programmable processors, memory, and can optionally include, in addition to hardware, computer programs and the ability to receive data from or transfer data to, or both, mass storage devices. A computer program, which may also be referred to or described as a program, software, a software application, an app, a module, a software module, a script, or code, can be written in any form of programming language, including compiled or interpreted languages, or declarative or procedural languages; it can be deployed in any form, including as a stand-alone program or as a module, component, subroutine, or other unit suitable for use in a computing environment deployed or executed on one or more computers.

Unless otherwise defined, all terms (including technical and scientific terms) used herein have the same meaning as commonly understood by one having ordinary skill in the art to which this invention belongs. In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. The specification and claims should be read with the understanding that such combinations are entirely within the scope of the invention and the claims.

It will nevertheless be understood that no limitation of the scope is thereby intended, such alterations and further modifications in the illustrated invention, and such further applications of the principles as illustrated therein being contemplated as would normally occur to one skilled in the art to which the embodiments relate. The present disclosure is to be considered as an exemplification of the invention, and is not intended to limit the invention to the specific embodiments illustrated by the figures or description below.

System, method, apparatus, and program instruction for Named Entity Recognition using Capsule Networks is provided. Such an invention allows for the more efficient processing of natural language data. The disclosed invention leverages the CapsNet architecture for improved NE identification and classification. This is done by deriving the features of an input text. The derived features are used to identify and classify any named entities in the text. The system is further configured to identify named entities in the text and perform clustering to group named entities. Clustering allows for the creation of new classes that might have been previously missed and the splitting of existing classes to classify named entities more specifically. An explanation for identifying and classifying named entities in the context of a text using CapsNet follows.

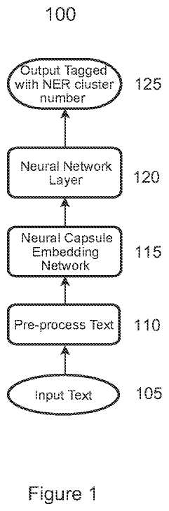

As illustrated in FIG. 1, a disclosed system 100, configured to identify and classify named entities, is provided. Such a system can have installed on it software, firmware, hardware, or a combination of them that in operation causes the system to perform operations or actions. The system receives a natural language input 105 stored in memory or accessed from another computer. This disclosure contemplates different natural language text lengths and formats as input. The input sentence in the depicted embodiment is an example, and no limitation is intended.

In the preferred embodiment, the input is pre-processed 110 using different NLP libraries to identify features of the natural language text that will be provided to and used by the CapsNet. This includes linguistic and semantic features of the text. Instead of assuming that the model can pick up all features on its own, the inclusion of linguistic features in the capsules ensures that the model can use all of the features to better identify and classify named entities in the text. The text is fed through parsers to determine these NER features, which can be divided into two subsets of features: features for NE identification and features for NE classification. NE identification features include, but are not limited to, part of speech tags, constituency parsing, relations between words, and conjunctions. NE classification features include, but are not limited to, dependency relations, prepositions, and object types.

The Neural Capsule Embedding Network 115, after receiving the input, considers the context of the whole text to activate higher capsule layers in order to identify the named entities and classify them. The Neural Network Layer 120 performs post-processing on the output vector. The system output 125 contains each word in the input text tagged as either 0, not a named entity, or an integer corresponding to the class that the named entity is grouped with.

While the disclosed model supports a predefined set of named entity classes, the preferred embodiment supports up to 1000 undefined classes, termed clusters in this disclosure, such that the output vector values of named entities are set as an integer 1 to 1000 corresponding to the clusters. A smaller maximum number of clusters will result in clusters similar to traditional NER models. A larger maximum number of clusters will result in a finer level of granularity in the classification of named entities, as compared to traditional NER models. No limitation on the maximum number of clusters is intended.

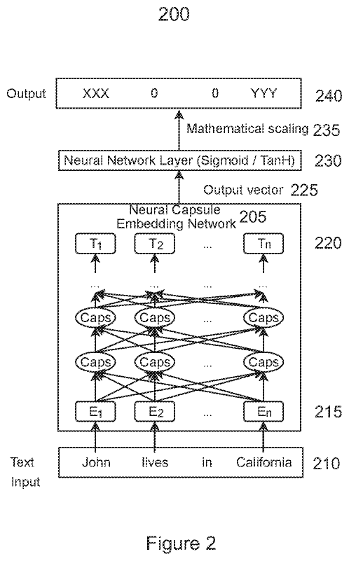

As illustrated in FIG. 2, an NER Capsule Network embodiment 200, configured to identify and classify named entities, is provided. An NER Capsule Network, appropriately configured in accordance with this specification, can perform the disclosed processes and steps. An embodiment of the NER Capsule Network can include a Neural Capsule Embedding Network 205 and a Neural Network Layer 230. The processes and steps described below can be performed by one or more computers or computer components or one or more computer or computer components executing one or more computer programs to perform functions by operating on input and generating output.

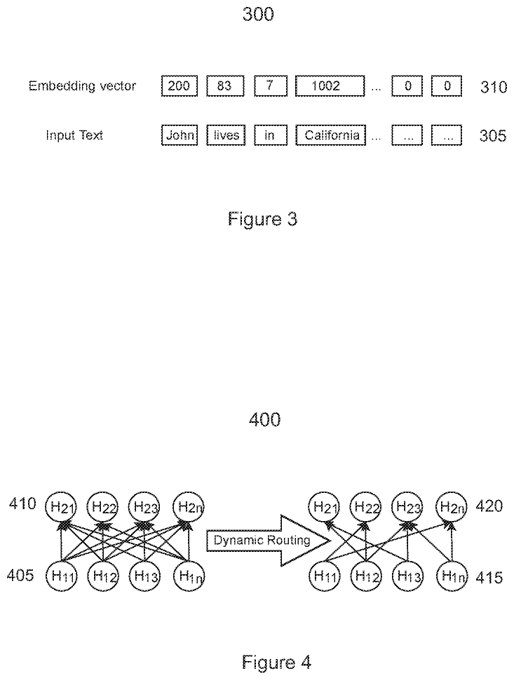

The Neural Capsule Embedding Network 205 is a CapsNet configured to receive a natural language text 210 as input in the depicted embodiment. Natural language text is comprised of one or more words, exemplified by the sentence, “John lives in California.” Because neural networks cannot read and understand text, the data is converted into numerical representations called embeddings 215. As illustrated in FIG. 3, the process 300 whereby each word in the input sentence (“John lives in California”) 305 passed to a Neural Capsule Embedding Network is first converted to embeddings (Eₓ) 310 is provided. In the preferred embodiment, the Neural Capsule Embedding Network is designed to accept a vector length of 512 embeddings (I_{L}). When receiving an input less than 512 words in length, embeddings following the text (that do not correspond to a word) are populated with the value of zero. Thus, for the example sentence “John lives in California,” four embeddings having values corresponding to the words and 508 embeddings having value 0, comprise the embedding vector. This disclosure contemplates Neural Capsule Embedding Networks having different maximum and minimum length embedding vectors and those capable of receiving variable length embedding vectors. This disclosure contemplates the conversion of natural language data 305 to embeddings 310 by the Neural Capsule Embedding Network or as part of pre-processing where the Neural Capsule Embedding Network would receive the embedding vector as input. The conversion of natural language data to embeddings can be local to the Neural Capsule Embedding Network 205 or separate. The format of the embedding vector can vary to additionally include other values that the system may use (with appropriate delimiters) but should contain the words of the input natural language text as embedding tokens.

Embodiments can vary in whether the features, to be evaluated by the Neural Capsule Embedding Network, are identified during pre-processing or by the Neural Capsule Embedding Network itself. In the preferred embodiment, the features of the text are identified during pre-processing and fed into the NER model. The features are converted to numerical representations and included with each word embedding that the feature is relevant to, as feature embeddings, such that each embedding in the embedding vector is itself a vector. For each word, any feature embeddings for features that are not relevant to a word are populated with the value of zero in order for the embedding vector for each word to be the same dimension. Alternatively, the linguistic features can be identified in the first step in the CapsNet.

A Neural Capsule Embedding Network 205 is comprised of stacked layers of capsules, where each capsule is initially linked to every other capsule in the adjacent layers, though these connections are pared down as a result of dynamic routing. The Neural Capsule Embedding Network 205 is a true CapsNet and not merely a limited number of capsule layers. Because increasing the number of layers above certain thresholds can saturate the network, in the preferred embodiment, the maximum number of layers is 30. This disclosure contemplates Neural Capsule Embedding Networks of other sizes and across one or more computers. The network is configured, for each word, to analyze and consider the tokens on both the left and right sides of the word to fully understand the context within the sentence. In the preferred embodiment, 10 tokens to the left (before) and 10 tokens to the right (after) of each word are considered, via capsule connections, in order to determine if the word is a named entity and group an identified named entity into clusters. This is an improvement over prior art processes which do not look at the words in both directions or, in implementations using Bidirectional LSTMs, which look to the left and right of the word separately and are not truly bidirectional. In the preferred embodiment, each capsule layer in the network has a hidden size of 2048 (H_{L}), though other sizes may be contemplated. Upon receiving the input, an intermediate hidden neural layer converts the input embedding size of I_{L} to the hidden size of H_{L} and projects it to the hidden capsule layers. The final layer 220 of the Neural Capsule Embedding Network is a Fully Connected Capsule Layer. The hidden layer before the Fully Connected Capsule Layer produces a matrix of dimension I_{L}×H_{L}. The matrix is flattened (all matrix elements placed in a single row) to a vector of dimension 1×I_{L}*H_{L} and passed to the Fully Connected Capsule Layer. The Fully Connected Capsule Layer converts the 1×I_{L}*H_{L} vector to one having dimensions of 1×I_{L}, the 1×I_{L} output vector 225 corresponding to the input embedding vector.

The capsule network is trained on a corpus of text to produce this output. Training is done by passing a known input, generating an output using the capsule network as it currently is, then comparing it to the known correct output and modifying the parameters (weights) accordingly to improve the accuracy of the results. In the preferred embodiment, the capsules and capsule connections are randomly initialized. Over time, the network is trained to generate the known output for all natural language data input. Training can be supervised, whereby there is a predefined set of named entity classes, and the system is configured to group any recognized named entities into the appropriate class. In the preferred embodiment, training is unsupervised, whereby there is a maximum number of clusters, and the system is configured to group any recognized named entities into as yet unidentified clusters. The clusters can later be identified during some form of post-processing.

As depicted in FIG. 4, dynamic routing of capsule networks 400 is the process whereby connections between lower level and higher level capsules are activated based on relevance to each other. Before dynamic routing, each capsule in a lower layer 405 is connected to each capsule in the layer above 410. Over the course of training, extraneous connections between capsules in a lower layer 415 and the later above 420 are identified and removed so that only the relevant connections remain. Capsules in a capsule layer can activate depending on their input data. Upon activation, the output of a lower capsule is routed to one or more capsules in the succeeding higher layer, abstracting away information while proceeding bottom-up. Capsules in a given capsule layer are configured to receive as input capsule outputs of one or more capsules of a previous capsule layer. The dynamic routing algorithm determines how to route outputs between capsule layers of the capsule network. As the capsules independently agree and converge to activate fewer and fewer higher level parent capsules, the overall complexity of the network at higher levels is reduced. Note that in a CapsNet, the higher layer capsules do not know what they represent in advance, so there is no prior assumption regarding the representations of higher layer capsules. Whereas for other architectures, such as those based on transformers, all layers have the same number of nodes, and the number of nodes is precisely the number of input tokens.

CapsNets are commonly employed in image recognition and classification due to their understanding of the spatial relationships of features in an image. For the image recognition process, CapsNet architecture involves capsules that take into consideration things like color, gradients, edges, shapes, and spatial orientation to identify object features and recognize the position and location of the features. As capsules agree on the features of the image, the output is routed to subsequent layers to the eventual identification of the image.

For Named Entity Recognition, the disclosed CapsNet is trained to analyze the input by evaluating linguistic features of a token in the context of the natural language text, such features including, but not limited to, part of speech tags, constituency parsing, relations between words, and conjunctions. The disclosed CapsNet is further trained to group a named entity into clusters by evaluating linguistic features of the named entity in the context of the text, such features including, but not limited to, dependency relations, prepositions, and object types. As capsules agree on the relevant features for identifying a named entity, the output of whether a word is a named entity or not a named entity is routed to subsequent layers. The capsules further agree on the relevant features used to classify a named entity and route the output of clustering of a named entity to subsequent layers. At the final capsule layer 220, the Neural Capsule Embedding Network 205 outputs a vector 225, corresponding to the input text in the depicted embodiment, though the Neural Capsule Embedding Network 205 can be configured to produce other outputs.

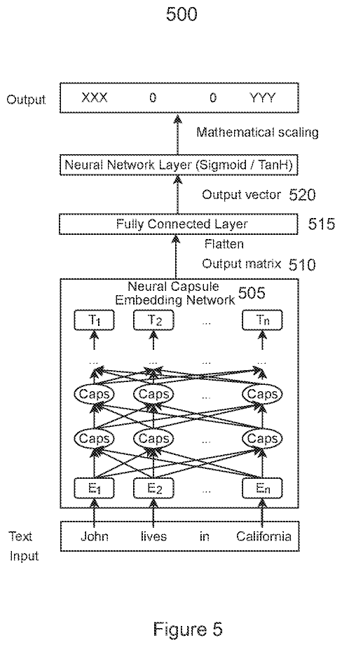

As illustrated in FIG. 5, an alternative NER Capsule Network embodiment 500, configured to identify and classify named entities, is provided. In the depicted embodiment, the Neural Capsule Embedding Network 505 is configured to produce an output matrix 510 of dimension I_{L}×H_{L}. The matrix is flattened to a vector of dimension 1×I_{L}*H_{L} and passed to a Fully Connected Layer 515. In the depicted embodiment, the Fully Connected Layer 515 is separate from the Neural Capsule Embedding Network and can comprise one or more computers, components, or program modules, residing local to the Neural Capsule Embedding Network 505 or separate. The Fully Connected Layer 515 converts the 1×I_{L}*H_{L} vector to one having dimensions of 1×I_{L}, the 1×I_{L} output vector 520 corresponding to the input embedding vector.

As depicted in FIG. 2, the output vector 225 is passed through a Neural Network Layer 230, which can comprise one or more computers, components, or program modules and can reside local to the Neural Capsule Embedding Network 205 or separate. The Neural Network Layer performs a function that transforms and normalizes the values in the vector. This can be done by a sigmoid function, which produces values ranging between 0 and 1, or a tanh function, which produces values ranging between −1 and 1, but other functions may be performed, and no limitation is intended. The values in the vector are then mathematically scaled 235 to 0 to the maximum number of clusters, which is 1000 in the preferred embodiment. A 0 indicates not a named entity and 1 through 1000 indicates the cluster to which the named entity belongs. If the range of values after the Neural Network Layer is 0 to 1, this can be performed with scalar multiplication. In some embodiments, as part of the mathematical scaling 235, a ceiling function or some other rounding function can be used to ensure that the mathematical scaling results in integer values. A ceiling function would be preferred to a floor function to prevent values below 1 that should be recognized as an NE from being rounded to 0 and thus not recognized as a named entity. In alternative embodiments, the Neural Network Layer and mathematical scaling functionalities can be performed by the Neural Capsule Embedding Network or after each layer in the Neural Capsule Embedding Network.

The output 240 of the NER Capsule Network is a vector, corresponding to the input text. In the preferred embodiment, each entry in the vector is tagged as either 0, indicating that the word is not a named entity, or an integer between 1 and 1000, specifying the cluster to which the named entity belongs. In the output 240 produced from the example sentence, “John lives in California,” the value XXX identifies a person cluster, the value YYY indicates a location cluster, and the value 0 identifies that the word is not a named entity. In some embodiments the clusters are limited to a predefined, smaller set of broad named entity classes. Alternatively, the clusters are groupings where the classes are later identified through post-processing.

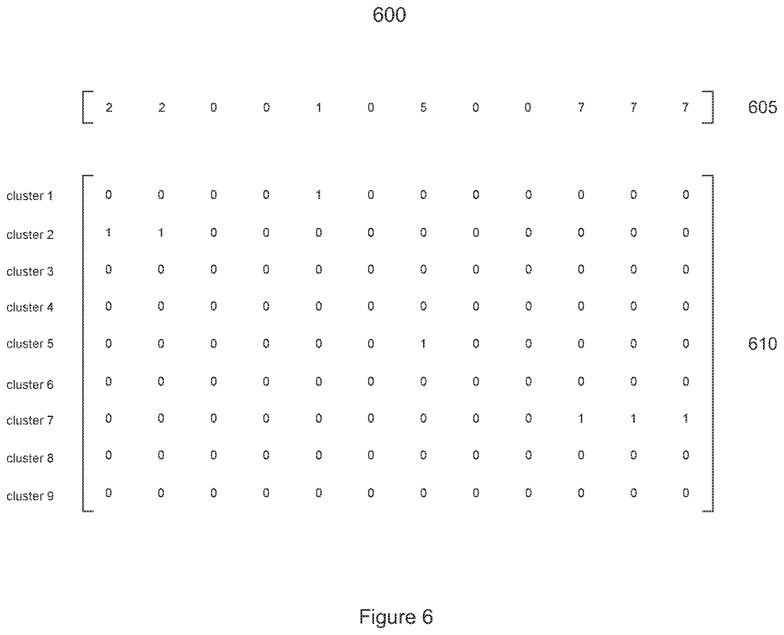

Post-processing can be further performed on the output vector. As depicted in FIG. 6, a process 600 of converting an output vector 605 to an output matrix 610 is provided. As depicted, each entry in the output vector, corresponding to a word in the input text, is tagged as either 0, indicating that the word is not a named entity, or an integer between 1 and the maximum number of clusters, specifying the cluster to which the named entity belongs. The vector is expanded to create a binary matrix having dimensions of the maximum number of clusters×input text length, where the maximum number of clusters in the depicted embodiment is 9. Alternatively, the vector can be expanded to create a binary matrix having dimensions of the number of clusters determined by the model×input text length. The columns correspond to the location of the word in the input text. The rows correspond to the cluster number. For each non-zero integer value in the vector, a 1 is inserted in a matrix cell, where the column is the position of each word in a named entity and the row is the cluster number corresponding to that NE. All other values in the matrix are 0. Thus, for the first vector value, a 2, in the output vector 605, a 1 is inserted into the cell of column 1 (input text position) and row 2 (cluster number) of the output matrix 610. Other forms of post-processing can include labeling or identification of clusters, expansion or splitting of clusters, and consolidation or combining of clusters.

The preceding description contains embodiments of the invention and no limitation of the scope is thereby intended. It will be further apparent to those skilled in the art that various modifications and variations can be made in the present invention without departing from the spirit or scope of the invention.

1. A computer-implemented method for named entity recognition, comprising:
receiving, into a neural capsule embedding network as input, an embedding vector, wherein the embedding vector contains embeddings representing words in a natural language text;
analyzing, by the neural capsule embedding network, the context of each word within the embedding vector considering tokens to the left and right of the word;
through dynamic routing of capsules, by the neural capsule embedding network, converging to a final capsule layer mapping to each word in the input vector;
generating, from the neural capsule embedding network, an output vector, wherein each output vector value:
a) identifies if a word in the input is a named entity or not a named entity;
b) if the word is a named entity, identifies what class the named entity belongs to.

2. The method of claim 1 further comprising:
before receiving, into a neural capsule embedding network as input, an embedding vector:
a) receiving, as input, a natural language text;
b) converting words in the natural language text into embeddings and inserting the embeddings into an embedding vector.

3. The method of claim 1, wherein generating, by the neural capsule embedding network, an output vector includes mathematical scaling of output vector values.

4. The method of claim 2, wherein converting words in the natural language text into embeddings includes populating, with the value of zero, any embeddings in the vector that do not correspond to a word.

5. The method of claim 1, further comprising:
after receiving, into a neural capsule embedding network as input, an embedding vector,
deriving, by the neural capsule embedding network, features of each word in the context of the natural language text.

6. The method of claim 1 further comprising:
before receiving, into a neural capsule embedding network, an embedding vector as input:
a) receiving as input a natural language text;
b) pre-processing the natural language text to identify features of the natural language text;
c) converting words in the natural language text into embeddings and inserting the embeddings into an embedding vector.

7. The method of claim 1, wherein classes are a predefined set of named entity classes.

8. The method of claim 1, wherein classes are clusters determined by the neural capsule embedding network.

9. The method of claim 1 further comprising:
after generating, by the neural capsule embedding network, an output vector, performing, by a neural network layer, mathematical scaling on the output vector values.

10. The method of claim 1 further comprising:
after generating, by the neural capsule embedding network, an output vector, converting the output vector into an output matrix by:
for each non-zero integer value in the output vector, inserting a 1 in an output matrix cell, where the column is the value's position in the output vector and the row is the class number.

11. The method of claim 1 further comprising:
before receiving, into a neural capsule embedding network as input, an embedding vector:
a) receiving, as input, a natural language text;
b) pre-processing the natural language text to identify features of the natural language text;
c) converting words in the natural language text into embeddings and inserting the embeddings into an embedding vector;
d) inserting the features as feature embeddings into the embedding vector.

12. The method of claim 1, wherein through dynamic routing of capsules, capsules agree on the features of words used to identify and classify a named entity.

13. A system for named entity recognition, comprising at least one processor, the at least one processor configured to cause the system to at least perform:
receiving, into a neural capsule embedding network as input, an embedding vector, wherein the embedding vector contains embeddings representing words in a natural language text;
analyzing, by the neural capsule embedding network, the context of each word within the embedding vector considering tokens to the left and right of the word;
through dynamic routing of capsules, by the neural capsule embedding network, converging to a final capsule layer mapping to each word in the input vector;
generating, by the neural capsule embedding network, an output vector, wherein each output vector value:
a) identifies if a word in the input is a named entity or not a named entity;
b) if the word is a named entity, identifies what class the named entity belongs to.

14. The system of claim 13 further comprising:
before receiving, into a neural capsule embedding network as input, an embedding vector:
a) receiving as input a natural language text;
b) converting words in the natural language text into embeddings and inserting the embeddings into an embedding vector.

15. The system of claim 13, further comprising:
after receiving, into a neural capsule embedding network, an embedding vector as input, deriving, by the neural capsule embedding network, features of each word in the context of the natural language text.

16. The system of claim 13 further comprising:
before receiving, into a neural capsule embedding network, an embedding vector as input:
a) receiving as input a natural language text;
b) pre-processing the natural language text to identify features of the natural language text;
c) converting words in the natural language text into embeddings and inserting the embeddings into an embedding vector.

17. The system of claim 13, wherein classes are a predefined set of named entity classes.

18. The system of claim 13, wherein classes are clusters determined by the neural capsule embedding network.

19. A computer-implemented method for named entity recognition, comprising:
receiving, into a neural capsule embedding network as input, an embedding vector, wherein the embedding vector contains embeddings representing words in a natural language text;
analyzing, by the neural capsule embedding network, the context of each word within the embedding vector considering tokens to the left and right of the word;
through dynamic routing of capsules, by the neural capsule embedding network, converging to a final capsule layer mapping to each word in the input vector;
generating, by the neural capsule embedding network, an output matrix, wherein the output matrix:
a) identifies if a word in the input is a named entity or not a named entity;
b) if the word is a named entity, identifies what class the named entity belongs to.

20. The method of claim 19 further comprising:
after generating, by the neural capsule embedding network, an output matrix, converting, by a Fully Connected Layer, a flattened output matrix into an output vector, wherein each output vector value:
a) identifies if a word in the input is a named entity or not a named entity;
b) if the word is a named entity, identifies what class the named entity belongs to.
